(19) United States
(12) Patent Application Publication
(10) Pub. No.: US 2026/0361667 A1
(43) Pub. Date: Nov. 12, 2026

(54) CREATING AND MANAGING AGENTS BASED ON CHAT CONVERSATIONS

(71) Applicant: International Business Machines Corporation, Armonk, NY (US)

(72) Inventors: Eileen Allen, Raleigh, NC (US); Jennifer M. Hatfield, Portland, OR (US); Mats Gothe, Norrköping (SE); RADCLIFFE Anthony SADDLER, Austin, TX (US); Ramona Sartipi, Toronto (CA); Corey Brinkmann, Wake Forest, NC (US)

(21) Appl. No.: 19/203,488

(22) Filed: May 9, 2025

(51) Int. Cl. H04L 51/02

(52) U.S. Cl. CPC H04L 51/02

(57) ABSTRACT

Creating and managing agents based on chat conversations is provided. This method includes receiving chat data associated with a first chat session between a first chat client and a conversational AI agent for a neural language model. The chat data is associated with a first task within an interconnected task sequence. The chat data is analyzed to generate an agent specification. A first AI agent is generated based on the agent specification. The generated first AI agent is activated within a multi-agent system, as part of a set of AI agents that includes the conversational AI agent.

### BACKGROUND

The disclosure relates to the artificial intelligence (AI) and more particularly, to agentic systems.

A gents are programs that utilize language models to interpret and respond to user inputs in real-time. These agents can manage a variety of functions, such as scheduling, information retrieval, and request processing, by understanding natural language. Integrated into various platforms, these agents can enhance user interactions by automating routine tasks and offering real-time support.

### SUMMARY

In various embodiments of the disclosure, a computer-implemented method for managing chat sessions with conversational AI agents is described. The method includes receiving, by a computer, chat data associated with a first chat session between a first chat client and a conversational AI agent for a neural language model. The method further includes analyzing, by the computer, the chat data to generate an agent specification. The method further includes generating, by the computer, a first AI agent based on the agent specification. The method further includes activating, by the computer, the generated first AI agent on a multi-agent system, as part of a set of AI agents that includes the conversational AI agent.

Further aspects of the present disclosure are directed to systems and computer program products containing functionality consistent with the method described above.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures, wherein:

FIG. 1 is a diagram that illustrates a computing environment for creating and managing Artificial Intelligence (AI) agents based on chat conversations, in accordance with an embodiment of the disclosure;

FIG. 2 is a diagram that illustrates an environment for creating and managing AI agents based on chat conversations, in accordance with an embodiment of the disclosure;

FIG. 3 is a sequence diagram that illustrates exemplary operations for generating AI agents, in accordance with an embodiment of the disclosure;

FIG. 4A and FIG. 4B are diagrams that collectively illustrate an exemplary conversation related to condition-based maintenance (CBM) process for generating AI agents, in accordance with an embodiment of the disclosure;

FIG. 5 is a diagram that illustrates a flowchart of an exemplary method for execution of AI agent for alert generation, in accordance with an embodiment of the disclosure;

FIG. 6A and FIG. 6B are diagram that illustrates an example dashboard for interacting with active AI agents, creating tasks, and reviewing task status, in accordance with an embodiment of the disclosure;

FIG. 7 is a block diagram that illustrates exemplary implementation of AI agents in a condition-based maintenance (CBM) process, in accordance with an embodiment of the disclosure; and

FIG. 8 is a diagram that illustrates a flowchart of an exemplary method for creating and managing AI agents based on chat conversations, in accordance with an embodiment of the disclosure.

### DETAILED DESCRIPTION

A gents that utilize language models are designed to interpret and respond to user inputs in real-time. These agents can manage a variety of functions, such as scheduling, information retrieval, and request processing, by understanding natural language. Integrated into various platforms, these agents enhance user interactions by automating routine tasks and offering real-time support, thereby increasing efficiency, and improving the user experience in digital environments. The concept of agents or a series of agents acting as change makers is rooted in their ability to observe productivity levels, processes, and usage patterns. Through this observation, the agents can identify gaps within the system and propose ways to repair or optimize based on these gaps. For example, an agent might notice that a particular process consistently takes longer than expected and suggest a more efficient workflow. These agents are continuously evolving and adapting into new and different types based on the need, environment, and supporting infrastructure. The agents operate autonomously or collectively, depending on the type of need, and determine the success threshold through benchmarking and analysis of change levels.

Conventional conversational AI assistants often fall short in handling repetitive, time-consuming tasks due to a lack of deep task comprehension, resulting in limited automation capabilities. For instance, an AI assistant might struggle to handle complex customer service inquiries that require understanding context from previous interactions. Additionally, users lack trust in these chat assistants to effectively remediate issues due to inconsistent performance. Users also struggle to initiate conversations when the assistant fails to provide clear guidance or context to get started, leading to frustration and inefficiency.

Users are often uncertain about how to begin processes or what specific questions to ask, leading to hesitation and delays. Chat interactions are linear and inefficient, requiring users to navigate through multiple queries without assurance of resolving their issues. This can be particularly frustrating in scenarios where quick resolution is critical. The lack of trust in automated issue resolution prevents full adoption of AI-driven remediation. Users may prefer manual intervention due to past experiences with unreliable AI solutions. The inability to retain previous conversation results in repetitive and inefficient interactions, as users have to re-explain their issues each time they interact with the assistant. Insufficient transparency in task execution reduces confidence in outcomes and decision-making, as users are unsure of how the AI reaches its conclusions.

The proposed system enables users to efficiently train and deploy AI agents through conversational AI techniques. For example, users can provide feedback on agent performance, which the system uses to improve future interactions. Queries are transformed into automated workflows, reducing manual tasks, and significantly speeding up processes such as customer support ticket resolution. Trust is built by monitoring AI performance and sharing ROI metrics, such as time saved, and issues resolved. This transparency helps users see the tangible benefits of AI integration. Workflows are continuously optimized, and new AI agents are recommended for deployment based on observed user behavior and needs, ensuring that the system remains relevant and effective over time.

The proposed system allows saving new AI agents based on contextual conversations, enabling AI agents to collaborate and address issues within a workflow without human intervention, monitoring agent activity and their business impact, recommending new AI agents based on user behavior, and consolidating AI agents into one central repository for quick access and management.

An agent library serves as a shared repository to oversee AI agents in the system, including their types, instances, properties, statuses, and histories. The library provides capabilities to manage the AI agents, including creating, activating, pausing, cloning, and deleting AI agents. For example, a user can quickly clone an existing agent to handle a new task, saving time and effort. A gent generators are experience patterns that are part of the business application, the agent library, or AI components to support the creation of AI agents. This feature allows for the rapid development and deployment of new AI agents tailored to specific needs.

AI agents may be configured into a network such as a multi-agent platform where the AI agents combine their skills to collaborate and perform workflows. AI agents may be configured statically with relations to collaborating AI agents or use discovery to dynamically find AI agent partners based on needs to accomplish tasks. For instance, an AI agent handling customer inquiry might collaborate with an AI agent specialized in technical support to resolve complex issues more efficiently. The proposed system provides a control tower, which provides an overview and drill-in to the status of the AI agents in the system, effectively monitoring AI agents at scale. Users can see real-time performance metrics and adjust as needed.

In some instances, the AI agent experience may take on archetypal roles such as Teacher, Assistant, Coach, and Co-worker, seamlessly appearing in the application experience based on its role. The system actively observes user behavior to continually improve, train AI agent, and generates recommendations for new AI agents. For example, an AI agent acting as a coach might provide tips and guidance to users based on their interaction history.

In various embodiments of the present disclosure, the technological field of artificial intelligence and process automation may be improved by configuring a system that integrates these capabilities into existing SaaS platforms for different applications, such as condition-based maintenance processes. By adding these capabilities, the disclosed system and method enables efficient training and deployment of AI and AI-based agents and reduce manual tasks.

In various embodiments of the disclosure, a computer-implemented method for managing chat sessions with conversational AI agents is described. The method includes receiving, by a computer, chat data associated with a first chat session between a first chat client and a conversational AI agent for a neural language model. The method further includes analyzing, by the computer, the chat data to generate an agent specification. The method further includes generating, by the computer, a first AI agent based on the agent specification. The method further includes activating, by the computer, the generated first AI agent on a multi-agent system, as part of a set of AI agents that includes the conversational AI agent.

In various embodiments of the disclosure, the method includes receiving a first set of queries associated with the first task via the first chat client during the first chat session. The method further includes executing the conversational AI agent, which comprises extracting context information comprising first data records associated with the first task based on the first set of queries. The method further includes generating prompts for the neural language model based on the first set of queries and the context information. The method further includes prompting the neural language model with the prompts to generate a first set of responses corresponding to the first set of queries. The chat data includes the first set of queries and the first set of responses, and the receiving of the chat data is performed based on the executing of the conversational AI agent.

In various embodiments of the disclosure, the method includes the conversational AI agent having access to a database storing the first data records or a sensor network generating the first data records.

In various embodiments of the disclosure, the method includes generating a set of field values corresponding to a set of fields of a template agent specification based on the analysis of the chat data. The method further includes populating the template agent specification with the set of field values to generate the agent specification.

In various embodiments of the disclosure, the method includes the analysis comprising executing the conversational AI agent to prompt the neural language model with an instruction that includes the chat data. The set of field values is generated as an output of the neural language model based on the instruction.

In various embodiments of the disclosure, the method includes the set of fields comprising one or more of: a role of a user associated with the first chat client, an access group that includes the user, a name of the first AI agent, a task scope, an agent goal, a state of the first AI agent, a group of users different than the user with access to the first AI agent, or a memory requirement for the first AI agent.

In various embodiments of the disclosure, the method includes executing the first AI agent activated on the multi-agent system, which comprises monitoring changes in first data records associated with the first task based on at least one of a task scope or an agent goal in the agent specification. The method further includes generating alert information based on the changes satisfying a trigger condition. The method further includes triggering the first chat client or a second chat client to display the alert information, the second chat client being different from the first chat client.

In various embodiments of the disclosure, the method includes the trigger condition being one of: a user-defined rule for columns in the first data records, an execution schedule specified in the agent specification, or an anomaly in at least one record of the first data records.

In various embodiments of the disclosure, the method includes executing the first AI agent activated on the multi-agent system, which comprises searching for a plurality of Application Programming Interface (API) endpoints available to the multi-agent system. The method further includes determining at least one API endpoint from the plurality of API endpoints which serves the first data records associated with the first task. The method further includes retrieving the first data records by calling the at least one API endpoint. The monitoring of the changes in the first data records is performed based on the retrieval.

In various embodiments of the disclosure, the method includes executing the first AI agent activated on the multi-agent system, which comprises training a machine learning model based on the first data records. The method further includes deploying the machine learning model on a production server.

In various embodiments of the disclosure, the method includes receiving a second set of queries via the first chat client or a second chat client during a second chat session for a second task of the interconnected task sequence. The method further includes executing a second AI agent of the set of AI agents to generate a set of recommendations, the generating of the set of recommendations being performed based on the second set of queries. The method further includes triggering the first chat client or the second chat client to display the set of recommendations.

In various embodiments of the disclosure, the method includes executing the conversational AI agent based on the second set of queries to trigger the execution of the second AI agent. The second AI agent is preconfigured for the second task on the multi-agent system and is different from the first AI agent.

In various embodiments of the disclosure, the method includes receiving a user selection of a recommendation from the set of recommendations via the first chat client or the second chat client. The method further includes executing the second AI agent to generate a work order regarding a third task of the interconnected task sequence.

In various embodiments of the disclosure, the method includes executing the second AI agent of the set of AI agents to analyze second data records associated with the work order. The method further includes generating a review status of the work order based on the analysis of the second data records. The method further includes sharing the review status with the conversational AI agent. The method further includes executing the conversational AI agent to render the review status on the first chat client or the second chat client.

In various embodiments of the disclosure, the method includes receiving a user input via the first chat client or a second chat client, the second chat client being different from the first chat client. The method further includes updating the agent specification based on the user input. The method further includes activating the first AI agent on the multi-agent system further based on the updating.

In various embodiments of the disclosure, the method includes forming a network of the set of AI agents with an interface for information exchange amongst at least two AI agents of the network.

In various embodiments of the disclosure, the method includes the interconnected task sequence being associated with a condition-based maintenance (CBM) process for assets. The interconnected task sequence includes one or more of a data aggregation task, an asset monitoring task, a data analysis task, a condition assessment task, a maintenance planning task, an inventory planning task, a maintenance scheduling task, a maintenance execution task, a work review task, or a feedback task.

In various embodiments of the disclosure, the method includes receiving a user input based on the activation of the first AI agent and performing a pause operation, a cloning operation, or a delete operation on the first AI agent activated on the multi-agent system based on the user input.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or various freely propagating electromagnetic waves, electromagnetic waves propagating through a waveguide, light pulses passing through a fiber optic cable, electrical signals communicated through a wire, and/or various transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

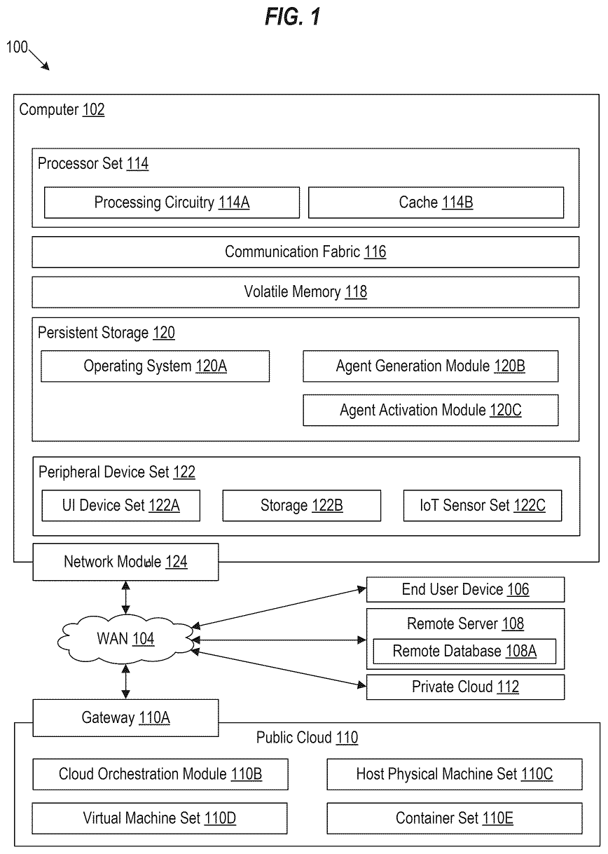

FIG. 1 is a diagram that illustrates a computing environment for creating and managing Artificial Intelligence (AI) agents based on chat conversations, in accordance with an embodiment of the disclosure. With reference to FIG. 1, there is shown a computing environment 100 that contains an example of an environment for the execution of at least some of the computer code involved in performing the disclosed methods, such as an agent generation module 120B, and an agent activation module 120C. In addition to the agent generation module 120B and the agent activation module 120C, computing environment 100 includes, for example, a computer 102, a wide area network (WAN) 104, an End User Device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A, the agent generation module 120B, and the agent activation module 120C, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or a wearable computer, a mainframe computer, a quantum computer, or any various forms of a computer or a mobile device now known or to be developed in the future that is capable of running a program, accessing a network or querying a database, such as the remote database 108A. As is well understood in the art of computer technology, and depending upon the technology, the performance of a computer-implemented method may be distributed among multiple computers and/or between multiple locations. In this presentation of the computing environment 100, detailed discussion is focused on a single computer, specifically the computer 102, to keep the presentation as simple as possible. The computer 102 may be located in a cloud, even though it is not shown in a cloud in FIG. 1. The computer 102 is not required to be in a cloud except to any extent as is affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the various storage media discussed below. The program instructions, and associated data, are accessed by the processor set 114 to control and direct the performance of the disclosed methods. In computing environment 100, at least some of the instructions for performing the disclosed methods may be stored in the dynamic modification of the agent generation module 120B and the agent activation module 120C in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Various types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to computer 102, but alternatively or additionally, the volatile memory 118 may be distributed over multiple packages and/or located externally with respect to computer 102.

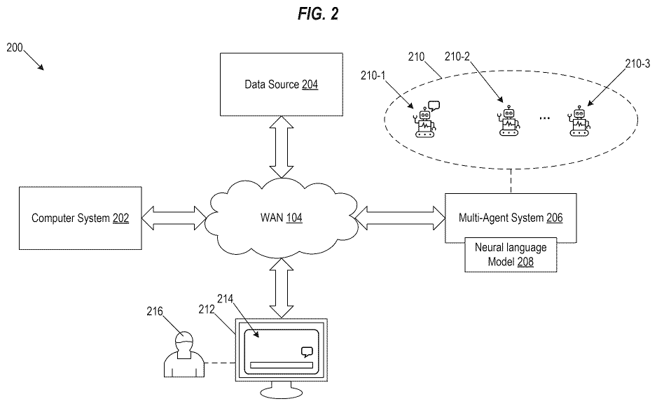

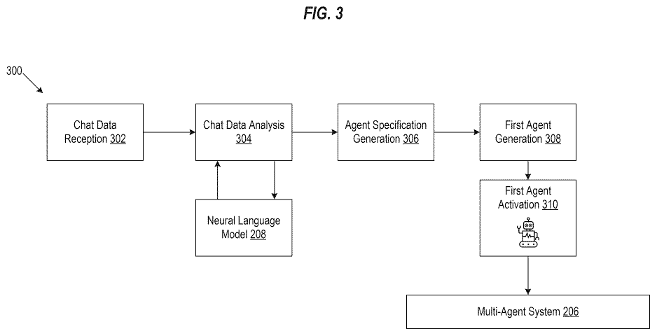

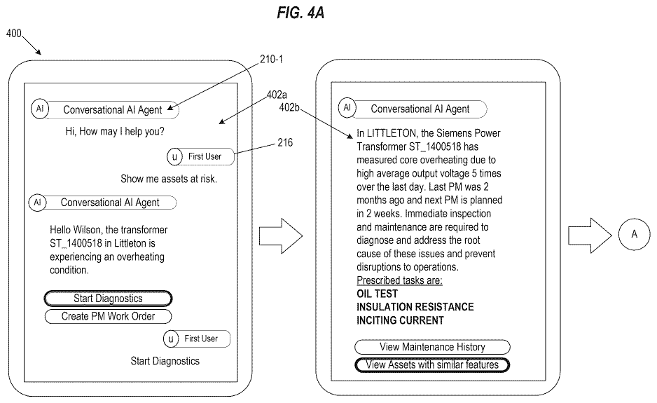

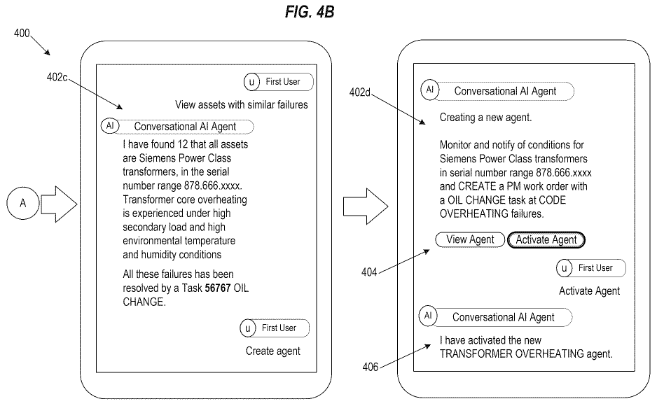

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 is a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the agent generation module 120B and the agent activation module 120C typically includes at least some of the computer code involved in performing the disclosed methods. The agent generation module 120B may include suitable logic, circuitry, code, and/or interface for generating AI agents (such as a first AI agent, a second AI agent, and so on) based on an agent specification. The agent specification is generated based on analysis of chat data between a conversational AI agent and a chat client of a user. Further details associated with the generation are provided, for example, in FIG. 3, FIG. 4A, and FIG. 4B. The agent activation module 120C may include suitable logic, circuitry, code, and/or interface for activating the generated AI agents on a multi-agent system (as shown in FIG. 2) for execution. Further details associated with the activation are provided, for example, in FIG. 3, FIG. 4A, and FIG. 4B.

The peripheral device set 122 includes the set of peripheral devices of computer 102. Data communication connections between the peripheral devices and the various components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A includes components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows computer 102 to communicate with various computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

FIG. 2 is a diagram that illustrates an environment for creating and managing AI agents based on chat conversations, in accordance with an embodiment of the disclosure. FIG. 2 is explained in conjunction with elements of FIG. 1. With reference to FIG. 1, there is shown a diagram of a network environment 200. The network environment 200 includes a computer system 202, a data source 204, a multi-agent system 206, a neural language model 208, a set of AI agents 210, and a user device 212. The multi-agent system 206 hosts a set of AI agents 210. The set of AI agents 210 includes, for example, a conversational AI agent 210-1, a first AI agent 210-2, a second AI agent 210-3, and the like. In accordance with an embodiment, the multi-agent system 206 further hosts the neural language model 208 or an Application Programming Interface (API) to access the neural language model 208. The user device 212 is configured to display a chat client 214 (also referred to as a first chat client). The user device 212 is associated with a user 216. The network environment 200 further includes the WAN 104 (as described in FIG. 1). In an embodiment of the disclosure, the user device 208 is an exemplary embodiment of the End User Device 106 of FIG. 1. Similarly, the computer system 202 is an exemplary embodiment of the computer 102 in FIG. 1.

The computer system 202 includes suitable logic, circuitry, and/or interfaces for receiving chat data associated with a first chat session between a first chat client (such as the chat client 214) and the conversational AI agent 210-1 for the neural language model 208. This chat data is linked to a first task within an interconnected task sequence. For example, the interconnected task sequence is related to a condition-based maintenance (CBM) process. The computer system 202 analyzes the chat data to generate an agent specification. The computer system 202 further generates the first AI agent 210-2 based on the agent specification. Finally, the computer system 202 activates the first AI agent 210-2 on the multi-agent system 206, integrating the first AI agent 210-2 with existing AI agents in the set of AI agents 210. Examples of the computer system 202 include, but are not limited to, a server, a computing device, a virtual computing device, a mainframe machine, a computer workstation, a smartphone, a cellular phone, a mobile phone, a gaming device, or a consumer electronic (CE) device. By way of example, and not limitation, the computer system 202 may be implemented as a cloud-based service, a cloud-based application, a cloud-based platform, a remote server-based service, a remote server-based application, a remote server-based platform, or a virtual computing system.

The data source 204 includes suitable logic, circuitry, and/or interfaces for storing data records pertaining to various processes at a facility. This data source 204 is configured to handle a wide range of information, ensuring that records are accurately maintained and easily accessible for analysis and decision-making. The data source 204 stores data from various sensors and systems, capturing parameters such as vibration levels, temperature, pressure, and electrical signals. These data records are crucial for monitoring equipment health, detecting anomalies, and predicting potential failures. Additionally, the data source 204 hosts APIs to serve this data, enabling seamless access for various applications and services, such as the set of AI agents 210. For example, in a condition-based maintenance (CBM) process, the data source 204 stores real-time condition data from sensors monitoring equipment health. Vibration data is used to detect imbalances or misalignments in machinery, temperature data is used to identify overheating issues in electrical systems, and pressure data is used to monitor fluid systems for leaks or blockages. Example implementations of the data source 204 include, but is not limited to, a server, a network attached storage (NAS), an edge device with storage, a distributed ledger, or a local storage disk.

The multi-agent system 206 is a computing system configured to support various applications and services by efficiently managing and processing data. The multi-agent system 206 includes hardware and software components such as compute clusters, storage systems, networking equipment, and specialized software for orchestrating interactions between multiple AI agents (such as the set of AI agents 210). Each AI agent operates independently based on rules and goals, but the AI agent may also collaborate with different AI agents on the multi-agent system 206 to solve complex problems. The environment, which may be physical, virtual, or a combination of both, provides a space for these interactions. The agent specifications outline each AI agent's capabilities, goals, and communication protocols. Integrating the neural language model 208 into the multi-agent system 206 allows for natural language query handling, enabling the multi-agent system 206 to interpret user queries, provide relevant responses, and facilitate communication between agents and users. For example, in a condition-based maintenance (CBM) process, AI agents monitor the real-time condition of assets using sensors to detect anomalies such as increased vibration or temperature. These AI agents then collaborate to schedule maintenance before a failure occurs, optimizing asset performance and reducing downtime.

In accordance with an embodiment, the multi-agent system 206 includes the computer system 202 as part of a compute component of the multi-agent system 206.

In accordance with an embodiment, the multi-agent system 206 includes an agent library, which is a centralized repository used to oversee and manage the set of AI agents 210 within the multi-agent system 206. The agent library stores information about the types and instances of agents, including their settings, statuses, and histories. The agent library provides various capabilities to manage these set of AI agents 210, such as creating, activating, pausing, cloning, and deleting the agents. This centralized management ensures that the set of AI agents 210 are accessible as needed. The multi-agent system 206 may host an interface that provides an overview and detailed status of the set of AI agents 210 in the multi-agent system 208. The interface serves as a primary front-end for the agent library, allowing users to monitor and manage the set of AI agents 210.

The neural language model 208 includes suitable logic, circuitry, and/or interfaces for processing natural language queries and generating responses to the queries. This neural language model 208, which is also referred to as a large language model (LLM), understands and generates human-like text, making the neural language model 208 effective for query response tasks. The neural language model 208 interprets user queries, provides relevant answers, and facilitates communication between the set of AI agents 210 within the multi-agent system 206. The architecture of the neural language model 208 is based on advanced neural network components, such as the transformer architecture. Transformers use self-attention mechanisms to capture long-range dependencies and contextual relationships within text, enabling the neural language model 208 to understand and generate coherent responses.

In accordance with an embodiment, the neural language model 208 may be a neural network. The neural network may be a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons). Outputs of all nodes in the input layer may be coupled to at least one node of hidden layer(s). Similarly, inputs of each hidden layer may be coupled to outputs of at least one node in different layers of the neural network. Outputs of each hidden layer may be coupled to inputs of at least one node in different layers of the neural network. Node(s) in the final layer may receive inputs from at least one hidden layer to output a result. The number of layers and the number of nodes in each layer may be determined from hyper-parameters of the neural network. Such hyper-parameters may be set before or after training the neural network on the training dataset.

The neural network may include electronic data, which may be implemented as, for example, a software component of an application executable on the multi-agent system 206. The neural network may rely on libraries, external scripts, or logic/instructions for execution by a processing device, such as the multi-agent system 206. The neural network may rely on code and routines to enable a computing device, such as the multi-agent system 206 to perform one or more operations, such as responding to queries provided via the set of AI agents 210. In some embodiments, the neural network may be implemented using hardware including a processor, a microprocessor (e.g., to perform or control performance of one or more operations), a field-programmable gate array (FPGA), or an application-specific integrated circuit (ASIC). Alternatively, in some embodiments, the neural network may be implemented using a combination of hardware and software.

Example implementations of the neural language model 208 may include, but are not limited to, a Bidirectional Encoder Representations from Transformers (BERT) model, a Generative Pre-trained Transformer (GPT) model (and its variants), Text-to-Text Transfer Transformer (T5) models, Long Short-Term Memory (LSTM) networks, attention-based models, multi-modal transformer models, fine-tuned large language models, encoder-decoder architectures, hierarchical neural language models, and reinforcement learning-based language models. The GPT model and its variants utilize layers of transformers to encode and decode text, capturing context and meaning through self-attention mechanisms.

Each AI agent of the set of AI agents 210 includes suitable logic, circuitry, and/or interfaces for executing tasks or responding to user queries by leveraging artificial intelligence techniques, such as machine learning (e.g., the neural language model 208) and natural language processing. The AI agent operates based on program instructions that are executable by the computer system 202 or the multi-agent system 206. The AI agent is configured to interact with users through natural language, providing responses or performing actions that mimic human-like understanding and behavior.

In the context of a Condition-Based Maintenance (CBM) process, the AI agent may assist in monitoring and maintenance of assets. For example, a predictive maintenance agent uses sensor data from machinery, such as temperature and vibration, to analyze and predict when a machine is likely to fail. This AI agent then notifies maintenance personnel to perform necessary repairs before a breakdown occurs, thereby preventing unexpected downtime. Further, an example is a diagnostic agent, which accepts inputs like error logs and performance metrics to diagnose the root cause of equipment malfunctions. This AI agent provides a detailed report on the likely cause and suggests corrective actions, helping maintenance teams address issues more efficiently. An optimization agent uses operational data and maintenance schedules to optimize maintenance plans. By balancing operational efficiency and resource utilization, this AI agent generates an optimized maintenance schedule that minimizes downtime and costs. Similarly, a conversational AI agent responds to user queries related to equipment status or maintenance procedures. By accessing information from maintenance databases and manuals, this AI agent provides accurate and timely responses to user questions.

In accordance with an embodiment, the AI agent may be configured for an archetypal role such as teacher, assistant, coach, and co-worker in operational workflows. The role allows the AI agent to seamlessly integrate into application experiences based on their specific functions. For example, a teacher AI agent provides instructional content or guidance, while an assistant AI agent helps with routine tasks and queries. A coach AI agent offers feedback and suggestions for improvement, and a co-worker AI agent collaborates on tasks and projects.

In accordance with an embodiment, the set of AI agents 210 is configured into an agentic network, where the set of AI agents 210 combines their skills to collaborate and perform workflows. The agentic network may be set up statically, with predefined relationships between the AI agents, or dynamically, where AI agents discover and partner with different AI agents based on the needs of a task.

In accordance with an embodiment, the computer system 202 actively monitors user behavior to update the agent specification corresponding to each of the set of AI agents 210. By observing how users interact with each AI agent, the computer system 202 may generate recommendations for new AI agents or enhancements to existing AI agents activated on the multi-agent system 206. This continuous improvement process ensures that the AI agents remain valuable and relevant, adapting to changing user needs and preferences.

The user device 212 is a digital interface that is configured to interact with the computer system 202 and/or the multi-agent system 206 for creating, managing, or invoking AI agents (such as set of AI agents 210) for various processes such as predictive maintenance or diagnostic analysis. Examples of the user device 212, includes but is not limited to, a computer, tablet, smartphone, or any digital device equipped with the necessary software and connectivity. By way of example, and not limitation, the user device 212 is an admin device used by system administrators to manage and initiate maintenance processes in the context of a condition-based maintenance (CBM) application. The user device 212 provides an interface to monitor system performance, submit maintenance requests, and receive maintenance recommendations, featuring dashboards, control panels, notification systems, reporting tools, and the like. In the context of equipment diagnostics, user device 212 may be used by maintenance engineers or analysts to initiate diagnostic processes. The user device 212 enables input of diagnostic requests, viewing of sensor data, and receiving of diagnostic recommendations, featuring data input forms, analytics dashboards, recommendation engines, access to historical data, and the like.

The chat client 214 includes suitable logic, circuitry, and/or interfaces for enabling real-time communication between the user 216 and an AI agent (of the set of AI agents 210). This chat client 214 is configured to operate on various digital devices such as computers, tablets, smartphones, or any device equipped with the necessary software and connectivity. The chat client 214 features text input fields, voice input options, multimedia support, and interactive elements such as buttons, quick replies, and menus to facilitate diverse forms of communication. Additionally, the chat client 214 includes functionalities such as message history, notifications, and customizable settings to enhance the user experience.

By way of example, and not limitation, the chat client 214 is used by the user 216 (who is a maintenance personnel) to communicate with diagnostic or predictive maintenance agents. The user 216 can input queries, receive real-time responses, and access maintenance recommendations directly through the chat client 214. For general user support, the chat client 214 enables users to ask questions, receive assistance, and interact with various AI agents configured to provide support, guidance, or information. The chat client 214 integrates with backend systems (e.g., the computer system 202 or the multi-agent system 206) to retrieve relevant data and provide accurate responses to user queries.

FIG. 3 is a sequence diagram that illustrates exemplary operations for generating AI agents, in accordance with an embodiment of the disclosure. FIG. 3 is explained in conjunction with elements from FIG. 1 and FIG. 2. With reference to FIG. 3, there is shown a sequence diagram 300 that includes operations from 302 to 310. The operations from 302 to 310 may be executed by any computing system, such as by the computer system 202 of FIG. 2 or the multi-agent system 206 of FIG. 2.

At 302, chat data associated with a first chat session may be received. The computer system 202 is configured to receive the chat data associated with a first chat session between the chat client 214 (also referred to as a first chat client) and the conversational AI agent 210-1 for the neural language model 208. In accordance with an embodiment, the reception of the chat data may be based on a user input (e.g., a generate command for an AI agent) included in the chat data.

The chat data is associated with a first task of an interconnected task sequence. By way of example, and not limitation, the interconnected task sequence is associated with a condition-based maintenance (CBM) process for assets. In the context of CBM process, the interconnected task sequence includes, but is not limited to, one or more of a data aggregation task, an asset monitoring task, a data analysis task, a condition assessment task, a maintenance planning task, an inventory planning task, a maintenance scheduling task, a maintenance execution task, a work review task, or a feedback task.

During the first chat session, the computer system 202 is configured to receive a first set of queries associated with the first task via the chat client 214. For instance, if the first task is a data aggregation task, the queries might include questions like “What are the latest sensor readings for asset X?” or “Can you provide the historical performance data for asset Y?” The computer system 204 then executes the conversational AI agent 210-1. This execution includes extracting context information, such as first data records related to the first task, based on the received queries. For example, if the query is about sensor readings, the context information might include recent data logs from various sensors attached to asset X. Thereafter, the computer system 202 generates prompts for the neural language model 208 based on the queries and the extracted context information. For instance, the prompt might be “Generate a summary of the latest sensor readings for asset X, highlighting any anomalies.”

The neural language model 208 is then prompted with these generated prompts to produce a first set of responses corresponding to the initial queries. For example, the response to the sensor reading query might be “The latest sensor readings for asset X show a temperature of 75 °C, which is within the normal range, but the vibration levels are higher than usual, indicating potential wear and tear.” In accordance with an embodiment, the chat data includes both the first set of queries and the corresponding responses. The reception of this chat data is based on the execution of the conversational AI agent 210-1, ensuring that the information relevant to the first task.

At 304, the chat data is analyzed. The computer system 202 is configured to analyze the chat data. As part of the analysis, the computer system 202 executes the conversational AI agent 210-1 to prompt the neural language model 208 with an instruction that includes the chat data. For example, if the chat data includes a query about asset maintenance schedules, the instruction might be “Analyze the maintenance schedule queries and generate relevant field values.” The neural language model 210-1 then processes this instruction and generates a set of field values based on the chat data. By way of example, and not limitation, the set of fields includes one or more of the following: a role of the user 216 associated with the chat client 214, an access group that includes the user 216, a name of the first AI agent 210-2, a task scope, an agent goal, a state of the first AI agent 210-2, a group of users different from the user with access to the first AI agent 210-2, or a memory requirement for the first AI agent 210-2. For instance, the user 216 might be identified as a “Maintenance Engineer,” belonging to an “Asset Management Team,” and the AI agent might be named “Maintenance_Bot.” The task scope may be defined as “Routine Maintenance Tasks,” with the agent goal being “Ensure all assets are maintained according to schedule.” The state of the first AI agent 210-2 might be “Active and Monitoring,” and the group of users could include “Supervisors and Technicians,” with a memory requirement of “yes”

The computer system 202 then generates a set of field values corresponding to these fields based on the analysis of the chat data. For example, if the chat data indicates that the user 216 is querying about maintenance schedules, the computer system 202 generates field values such as “Maintenance Engineer” for the user role, “Asset Management Team” for the access group, and “Routine Maintenance Tasks” for the task scope.

At 306, an agent specification is generated. The computer system 202 is further configured to generate the agent specification based on the analysis of the chat data. For instance, the computer system 202 populates a template agent specification with the generated set of field values (generated at 304). This means that the template, which defines the AI agent's configuration, is updated with specific details like the user's role, the access group, and the task scope. This may be done for ensuring that the first AI agent 210-2 operates effectively within the defined parameters and can accurately address the tasks assigned to the first AI agent 210-2. As an example, a portion of the agent specification as a JSON (JavaScript Object Notation) object is provided as follows:

```
{
  “user_role”: “Maintenance Engineer”,
  “access_group”: “Asset Management Team”,
  “ai_agent_name”: “Maintenance_Bot”,
  “task_scope”: “Routine Maintenance Tasks”,
  “agent_goal”: “Ensure all assets are maintained according to schedule”,
  “ai_agent_state”: “Active and Monitoring”,
  “different_users_with_access”: [“Supervisors”, “Technicians”],
  “memory_requirement”: “yes”,
...
}
```

The agent specification may be formatted and stored on the computing system 202 (or the multi-agent system 206) as one of, but not limited to, JSON, YAML, CSV, Protocol Buffers, Dictionary, Python Object, or Apache® Avro.

In accordance with an embodiment, the computer system 202 is also configured to receive a user input via the chat client 214. Alternatively, the user input is received via a chat client (not shown) different from the chat client 214. Such a chat client may be associated with a different user who is part of an access group for the first AI agent 210-2. For example, a supervisor may use a different chat client to provide additional instructions or updates. The computer system 202 then updates the agent specification based on this user input. The update ensures that the AI agent's configuration remains accurate and up to date. Further, this update allows for dynamic adjustments and continuous improvement of the AI agent's performance based on real-time feedback and changing requirements.

At 308, a first AI agent (such as the first AI agent 210-2) is generated based on the agent specification. The computer system 202 is further configured to generate the first AI agent 210-2 based on the agent specification. As part of the generation process, the agent specification, which includes detailed information about the AI agent's role, access permissions, task scope, goals, state, and similar relevant parameters, is used as a blueprint for generating the first AI agent 210-2. Depending on the agent's goal and scope in the agent specification, the first AI agent 210-2 is configured with the necessary capabilities to perform functions.

Some examples of such capabilities are provided herein. For instance, the first AI agent 210-2 is configured for web browsing, which allows the first AI agent 210-2 to access and retrieve information from the web to gather latest data, research, or updates relevant to the task. For instance, the first AI agent 210-2 is configured to crawl or browse the web for the latest maintenance techniques or industry standards to provide up-to-date recommendations.

In some instances, the first AI agent 210-2 is configured to perform API calling, enabling the AI agent 210-2 to interact with various external systems and services, such as the data source 204. This may allow the first AI agent 210-2 to retrieve real-time data, update records, or trigger actions. For example, the first AI agent 210-2 is configured to call an API to retrieve the latest sensor data from an asset monitoring system or to update a maintenance schedule in a management system.

In some instances, the first AI agent 210-2 is configured to perform data analysis on datasets to identify patterns, trends, and anomalies. This may be relevant for tasks such as condition-based maintenance, where the first AI agent 210-2 needs to assess the health of assets based on sensor data and historical performance.

In some instances, the first AI agent 210-2 is configured for Natural Language Processing (NLP) to parse human language in the queries and to enable interactions with users through chat clients. Additionally, or alternatively, the first AI agent 210-2 is configured to use machine learning models to generate predictions from data (such as sensor records), classify data, or train the models on new data. For example, the first AI agent 210-2 may use predictive models to forecast when an asset is likely to fail and recommend preemptive maintenance actions. The first AI agent 210-2 is also configured for task automation, which allows the first AI agent 210-2 to streamline operational workflows by automating repetitive tasks such as scheduling maintenance activities, generating reports, or sending notifications.

In some instances, the first AI agent 210-2 includes an integration with Internet of Things (IoT) devices. Such an integration enables the first AI agent 210-2 to connect to and interact with IoT devices to monitor asset conditions in real-time or near real-time. This includes receiving data from the IoT devices, controlling such devices, and responding to alerts or anomalies detected in IoT network of such devices.

In some instances, the first AI agent 210-2 is configured to manage and utilize a knowledge base (e.g., a locally cached copy of the data records on the data source 204) to provide accurate and contextually relevant information. This includes accessing stored documents, manuals, and guidelines to support decision-making processes. The first AI agent 210-2 is configured for user role management, which ensures that the first AI agent 210-2 handles different user roles and permissions.

In accordance with an embodiment, the first AI agent 210-2 is generated based on a prebuilt agent class. The agent class includes predefined methods for setting up the agent's environment, loading models, and integrating with data sources (such as the data source 204). For instance, the agent class may have functions to establish connections to real-time sensor data, load pre-trained machine learning models, and integrate with systems or tools required for the operation of the first AI agent 210-2. The computer system 202 initializes the first AI agent 210-2 by instantiating an object of the prebuilt agent class using the specified parameters from the agent specification. This may involve passing the detailed information from the agent specification to the agent class, which then configures the first AI agent 210-2 accordingly.

In accordance with an embodiment, the first AI agent 210-2 is configured to access the neural language model 208 and/or AI components required to process queries, generate responses, and perform tasks as defined in the agent specification. This might include loading pre-trained models or generating API calls to the pre-trained models and configuring natural language processing (NLP) operations. For example, the first AI agent 210-2 is configured to use a specific language model to understand and respond to maintenance-related queries from users.

In accordance with an embodiment, the computer system 202 executes a series of tests to ensure that the first AI agent 210-2 operates correctly and meets the requirements specified in the agent specification, once the first AI agent 210-2 is configured. This may include running simulated tasks, checking the accuracy of the responses generated by the first AI agent 210-2, and verifying that the first AI agent 210-2 can handle various scenarios that the first AI agent 210-2 may encounter during operation. For example, the computer system 202 may test the ability of the first AI agent 210-2 to generate accurate maintenance recommendations based on different sets of sensor data.

At 310, the generated first AI agent 210-2 is activated on the multi-agent system 206. The computer system 202 activates the generated the first AI agent 210-2 as part of the set of AI agents 210 that includes the conversational AI agent 210-1. As part of the activation, the first AI agent 210-2 is deployed on the multi-agent system 206 and is made available for use via the agent library (accessible via the user device 212).

In accordance with an embodiment, the computer system 202 continuously monitors the performance of the activated first AI agent 210-1 and updates the agent specification (or agent configuration) associated with the activated first AI agent 210-1 based on the performance. This may be done to ensure that the activated first AI agent 210-1 remains up to date with the new resource information (e.g., new assets for monitoring), ML models, or callable tools added to the multi-agent system 206. Additionally, this may involve updating the AI agent's models, refining agent operations, or modifying agent's configuration based on feedback and new requirements. For example, if the AI agent's performance in generating maintenance recommendations needs improvement, the computer system 202 may update the machine learning models with new training data. In accordance with an embodiment, the computer system 202 activates the first AI agent 210-2 on the multi-agent system 206 further based on the update of the agent specification. The update may be performed based on a user input (as described at 306) or the performance.

In accordance with an embodiment, the computer system 202 receives a user input based on the activation of the first AI agent 210-2. The user input may be provided via the first chat client 214 or a dashboard rendered on the user device 212 for managing AI agents. Based on the user input, the computer system 202 is configured to perform a pause operation, a cloning operation, or a delete operation on the first AI agent 210-2 within the multi-agent system 206.

For instance, when the first AI agent 210-2 is activated and the user 216 decides that the current task of the first AI agent 210-2 should be temporarily halted, the user 216 can issue a pause command (included in the user input). The pause operation, when performed, suspends the activities of the first AI agent 210-2 without terminating its session, allowing the user 216 to resume the task at a later time. For example, suppose an AI agent is processing customer support tickets. The user 216 realizes that an urgent task requires immediate attention and decides to pause the first AI agent 210-2. The user 216 inputs the pause command, and the first AI agent 210-2 stops processing the tickets. When the urgent task is completed, a resume operation is performed (based on a new user input) and the first AI agent 210-2 resumes the operation to continue processing the tickets. Similarly, the cloning operation includes creating an exact copy of the first AI agent 210-2, including its current state and task parameters (as defined in the agent specification). This operation is useful when the user 216 needs multiple agents performing similar tasks simultaneously. For instance, if the first AI agent 210-2 is executed to analyze sales data and generate reports. The user 216 needs to generate similar reports for different regions simultaneously. By issuing a clone command, the computing system 202 generates multiple copies of the first AI agent 210-2, each assigned to analyze data for a specific region. This may speed up the overall task completion. Additionally, the delete operation terminates the first AI agent 210-2 and removes the first AI agent 210-2 from the multi-agent system 206. This may be useful when the task of the first AI agent 210-2 is complete, or the first AI agent 210-2 is no longer needed. For instance, consider that the first AI agent 210-2 is activated to monitor and report on a specific marketing campaign. Once the campaign ends and the final report is generated, the user 216 can issue a delete command to terminate the first AI agent 210-2. This ensures that resources of the multi-agent system 206 are not wasted on an inactive agent.

FIG. 4A and FIG. 4B are diagrams that collectively illustrate an exemplary conversation related to condition-based maintenance (CBM) process for generating AI agents, in accordance with an embodiment of the disclosure. FIG. 4A and FIG. 4B are explained in conjunction with elements from FIG. 1, FIG. 2, and FIG. 3. With reference to FIG. 4A and FIG. 4B, there is shown a chat client 400 at different time steps during a chat session. The chat client 400 displays chat data 402a, 402b, 402c, 402d between a first user (such as the user 216 who may be a reliability engineer) and the conversational AI agent 210-1.

As shown, for example, the chat data 402a, 402b, 402c, 402d includes a first query of a set of queries, such as “Show me assets at risk” to the conversational AI agent 210-1. The first query is provided by the user 216 via an input UI element in the chat client 400. After receiving the first query associated with a first task of identifying assets at risk via the chat client 400 during the chat session, the computer system 202 executes the conversational AI agent 210-1. The execution includes extracting context information including first data records related to asset conditions and maintenance history associated with the first task based on the first query, generating prompts for the neural language model 208 based on the first query and the context information, and prompting the neural language model 208 with the prompts to generate a first response corresponding to the first query. As shown, for example, the response includes an identification of a specific asset at risk, such as “Hello Wilson, the transformer ST_1400518 in Littleton is experiencing an overheating condition.”

Similarly, the computer system 202 further executes the conversational AI agent 210-1 to provide options for the user 216 to proceed, such as “Start Diagnostics” and “Create PM Work Order.” The computer system 202 receives a user selection (as part of the set of queries), and the computer system 202 further executes the conversational AI agent 210-1 to generate a detailed condition report, including information such as “In LITTLETON, the Siemens Power Transformer ST_1400518 has measured core overheating due to high average output voltage 5 times over the last day. Last PM was 2 months ago, and next PM is planned in 2 weeks. Immediate inspection and maintenance are required to diagnose and address the root cause of these issues and prevent disruptions to operations. Prescribed tasks are OIL TEST, INSULATION RESISTANCE, INCITING CURRENT.”

The computer system 202 also executes the conversational AI agent 210-1 to provide additional options, such as “View Maintenance History” and “View Assets with similar features.” The computer system 202 receives a user selection (as part of the set of queries) for similar failures, and further executes the conversational AI agent 210-1 to respond with a report, such as “I have found 12 assets that are all Siemens Power Class transformers, in the serial number range “878.666.xxxx”. Transformer core overheating is experienced under high secondary load and high environmental temperature and humidity conditions.”

The computer system 202 receives a user selection (as part of the set of queries) to create an agent (such as the first AI agent 210-1), and the computer system 202 further executes the conversational AI agent 210-1 to generate the first AI agent 210-1 as a new monitoring agent, stating, “Creating a new agent. Monitor and notify of conditions for Siemens Power Class transformers in serial number range 878.666.xxxx and CREATE a PM work order with an OIL CHANGE task at CODE OVERHEATING failures.” The computer system 202 further executes conversational AI agent 210-1 to display options 404 to “View Agent” and “Activate Agent.” Finally, the computer system 202 receives a user selection (as part of the set of queries) of an option to activate the first AI agent 210-1 and further executes the conversational AI agent 210-1 to confirm the activation with a response 406 such as “I have activated the new TRANSFORMER OVERHEATING agent.”

To generate the first AI agent 210-1, the computer system 202 is further configured to generate the agent specification based on the analysis of the chat data 402. For instance, the computer system 202 populates a template agent specification with a set of field values. This means that the template, which defines the AI agent's configuration, is updated with specific details like the user's role, the access group, and the task scope. This ensures that the first AI agent 210-1 operates effectively within the defined parameters and can accurately address the tasks assigned to the first AI agent 210-1. For example, a portion of the agent specification as a JSON (JavaScript Object Notation) object is provided as follows:

```
{
  “user_role”: “Reliability Engineer”,
  “access_group”: “Asset Management Team”,
  “ai_agent_name”: “TransformerOverheatMonitor”,
  “task_scope”: “Monitor and address transformer overheating issues”,
  “agent_goal”: “Ensure all transformers operate within safe temperature
  ranges”,
  “ai_agent_state”: “Active and Monitoring”,
  “different_users_with_access”: [“Supervisors”, “Technicians”],
  “memory_requirement”: “yes”,
  “tasks”: [
    {
      “task_name”: “OIL TEST”,
      “task_code”: “56767”,
      “task_description”: “Perform oil test to check for overheating
      indicators”
    },
    {
      “task_name”: “INSULATION RESISTANCE”,
      “task_code”: “56768”,
      “task_description”: “Measure insulation resistance to ensure
      safety”
    },
    {
      “task_name”: “INCITING CURRENT”,
      “task_code”: “56769”,
      “task_description”: “Check inciting current to diagnose
      overheating causes”
    }
  ]
}
```

The agent specification may be formatted and stored on the computing system 202 (or the multi-agent system 206) as one of, but not limited to, JSON, YAML, CSV, Protocol Buffers, Dictionary, Python Object, or Apache® Avro. Further details related to the generation of the first AI agent 210-1 are provided, for example, in FIG. 3.

In accordance with an embodiment, to execute the tasks in the agent specification, the computer system 202 executes the first AI agent 210-2 to access the data records associated with the task (stored on the data sources 204) via API or different data access protocols. The computer system 202 then further executes the first AI agent 210-2 to prompt the neural language model 208 or apply pretrained ML models to analyze the data records and generate a suitable response (e.g., asset risk classification using oil test data). The execution may be performed periodically based on a schedule or a user input (e.g., via the chat client). This process may ensure that the first AI agent 210-2 accurately monitors transformer conditions, diagnoses issues, and recommends appropriate maintenance actions based on real-time and historical data records.

It should be noted that the examples discussed in FIG. 4A and FIG. 4B are for exemplary purposes, and such examples should not be construed as limiting the present disclosure.

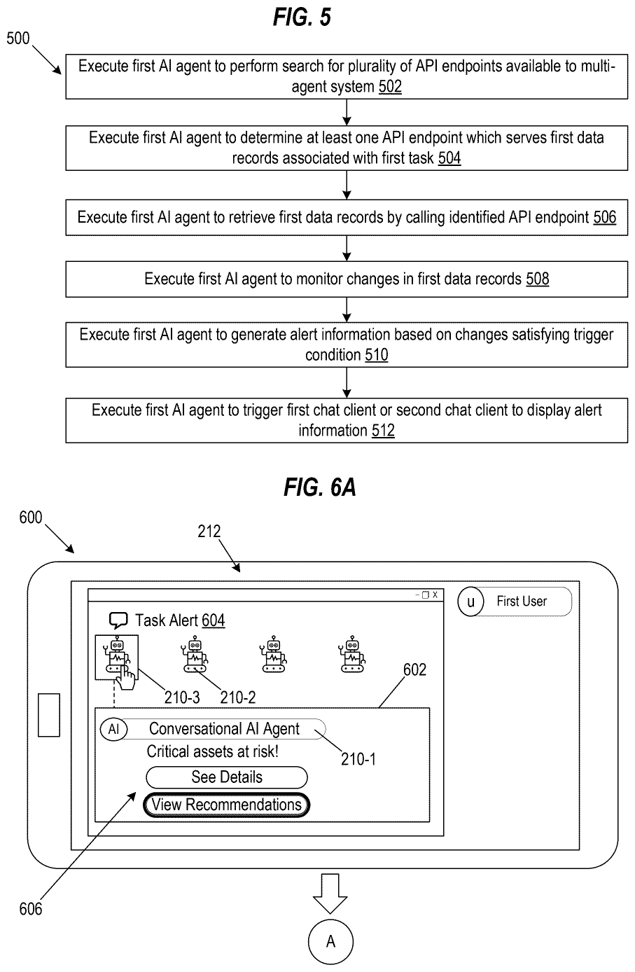

FIG. 5 is a diagram that illustrates a flowchart of an exemplary method for execution of AI agent for alert generation, in accordance with an embodiment of the disclosure. FIG. 5 is explained in conjunction with elements from FIG. 1, FIG. 2, FIG. 3, FIG. 4A, and FIG. 4B. With reference to FIG. 5, there is shown a flowchart 500. The operations of the exemplary method may be executed by any computing system, for example, by the computer 102 of FIG. 1 or the computer system 202 of FIG. 2. The flowchart 500 includes operations from 502 to 512, which may be executed after the activation of an AI agent (such as the first AI agent 210-2). The operations of the flowchart 500 may start at 502.

At 502, a search for the plurality of API endpoints available to the multi-agent system 206 may be performed. The computer system 202 is configured to execute the first AI agent 210-2 to perform the search for the plurality of API endpoints available to the multi-agent system 206. For example, the computer system 202 may query a service registry or a configuration database to identify all available API endpoints that may be used to access data relevant to the tasks of the multi-agent system 206.

At 504, at least one API endpoint is determined from the plurality of API endpoints. The computer system 202 is configured to execute the first AI agent 210-2 to determine the at least one API endpoint which serves first data records associated with the first task. This may include analyzing metadata and capabilities of each API endpoint to identify those API endpoints that provides necessary data, such as data records for monitoring transformer conditions and maintenance history. For instance, the computer system 202 executes the first AI agent 210-2 to identify an API endpoint that provides real-time temperature readings and maintenance logs for transformers.

At 506, first data records are retrieved. The computer system 202 further executes the first AI agent 210-2 to retrieve the first data records by calling the identified API endpoint. This retrieval process includes sending a request to the API endpoint and receiving the first data records in response. The retrieved data records may include information such as temperature readings, voltage levels, and maintenance history for the transformers.

At 508, changes in the first data records are monitored. The computer system 202 further executes the first AI agent 210-2 to monitor the changes in the first data records associated with the first task based on at least one of a task scope or an agent goal in the agent specification. The monitoring of changes in these data records is performed based on the retrieval, ensuring that the first AI agent 210-2 has the most up-to-date information about the status of the assets such as the transformers. For example, if the agent's goal is to monitor transformer overheating, the computer system 202 executes the first AI agent 210-2 to continuously check for any significant changes in temperature readings or voltage levels that might indicate an overheating condition. This monitoring process ensures that any potential issues are detected promptly.

At 510, alert information is generated based on the changes satisfying a trigger condition. The computer system 202 is further configured to execute the first AI agent 210-2 to generate alert information based on the changes satisfying the trigger condition. The trigger condition may be one of a user-defined rule for columns in the first data records, an execution schedule specified in the agent specification, or an anomaly in at least one record of the first data records. For instance, if the temperature of a transformer exceeds a predefined threshold, an alert is generated to notify the maintenance team of a potential overheating issue. Through the chat client, a task notification alert may be displayed to all users (authorized to use the first AI agent 210-2) including the user 216.

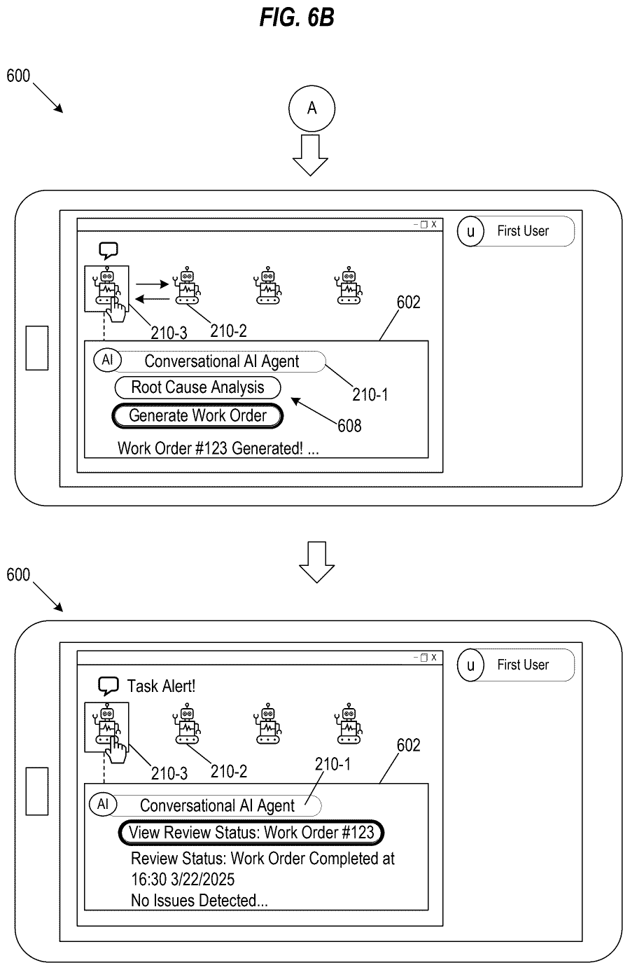

At 512, a first chat client or a second chat client is triggered to display the alert information. The computer system 202 is further configured to execute the first AI agent 210-2 to trigger the first chat client (such as the chat client 214) or the second chat client to display the alert information. The second chat client may be different from the first chat client and may be used by different members of the maintenance team or supervisors. For example, if an alert is generated for a transformer overheating condition, the computer system 202 is further configured to execute the first AI agent 210-2 to generate and transmit a notification to the chat clients of the maintenance engineer and the supervisor, ensuring that both are aware of the issue and can take appropriate action. The supervisor can view details and explainability provided by on the respective chat client, including feedback on root cause, confidence, and the data and models used in the analysis. Further details related to the execution are provided in FIG. 6A and FIG. 6B, for example.

In accordance with an embodiment, the computer system 202 is further configured to execute the first AI agent 210-2 to train a machine learning model based on the first data records and deploy the machine learning model on a production server (such as the multi-agent system 206). The training of the machine learning model includes using the first data records, which include historical data on transformer operations, to build a prediction model. This model is trained to identify patterns and predict future conditions based on time-series data. Once the model is trained, the model is deployed on the production server, where the model operates in real-time to monitor asset condition, such as transformer conditions and predict potential issues. By deploying the machine learning model on the production server, the computer system 202 enables the first AI agent 210-2 or existing AI agents (active on the multi-agent system 206) to apply the machine learning model to continuously monitor asset data such as transformer data, generate predictions, and trigger alerts when necessary.

In some instances, a data scientist is working on a new foundation model for time-series predictions. Using the agent library, the computer system 202 receives an input from the data scientist to generate, simulate, and test the new AI agent (e.g., based on the first AI agent 210-2). The process begins with a chat where the data scientist defines the role, description, and outcome of the new AI agent. The computer system 202 executes the new AI agent to discover APIs for a new prediction model, providing the new AI agent with access to current and historical data from an operational transformer. Through a simulation interface, the data scientist initiates a simulation, during which the new AI agent collaborates with existing agents (such as the first AI agent 210-2 and the conversational AI agent 210-1) in the set of AI agents 210 to collect and aggregate the necessary data. The predictions generated by the new AI agent are reviewed, and the data scientist tunes the thresholds for actions based on these predictions. Once satisfied with the performance, the computer system 202 receives an input from the data scientist to save the new AI agent and activate the new AI agent in a test mode. In some instances, the data scientist returns to review the test results on an automatically generated control tower dashboard. This dashboard provides a comprehensive view of the agent's performance, including predictions, accuracy, and any anomalies detected. Based on the test results, the computer system 202 receives an input from the data scientist to update the new AI agent and activate the new AI agent in production mode. Based on the input, the computer system 202 activates the new AI agent in the production mode.

FIG. 6A and FIG. 6B are diagram that illustrates an example dashboard for interacting with active AI agents, creating tasks, and reviewing task status, in accordance with an embodiment of the disclosure. FIG. 6A and FIG. 6B are explained in conjunction with elements of FIG. 1, FIG. 2, FIG. 3, FIG. 4A, FIG. 4B, and FIG. 5. With reference to FIGS. 6A and 6B, there is shown an example dashboard 600 at three distinct timesteps, each illustrating different stages of interaction and task execution by the AI agents.

In the first timestep, the computer system 202 is configured to receive a first query of a set of queries (also referred to as a second set of queries) via a first chat client or a second chat client 602 (e.g., a chat client associated with a user different from the user 216) during a second chat session for a second task of the interconnected task sequence. For instance, the maintenance supervisor is notified that a critical asset is at risk and the first query is related to a state of the critical asset. The dashboard 600 is configured with a card presenting the output of the second AI agent (in the network of AI agents) identifying and listing critical assets at risk. The supervisor can view details and explainability provided by the first AI agent 210-2, including feedback on root cause, confidence, and the data and models used in the analysis. The computer system 202 then executes the conversational AI agent 210-1 based on the first query to trigger the execution of the second AI agent 210-3, which is preconfigured for the second task and is different from the first AI agent 210-2. The dashboard 600 displays UI elements representing AI agents in the agent library, alongside a task alert 604 generated by the second AI agent 210-3 (e.g., based on inputs from the first AI agent 210-2). The task alert 604 indicates that there are critical assets at risk, prompting the user 216 with options 606 to “See Details” or “View Recommendations.”

The computer system 202 receives a user selection of the option “View Recommendations” as a second query of the set of queries. The computer system 202 further executes the second AI agent 210-3 to generate a set of recommendations 608 based on the second query and triggers the second chat client 602 to display these set of recommendations 608. As shown, for example, the dashboard 600, based on the user selection, displays the conversational AI agent 210-1 providing the set of recommendations 608 such as “Root Cause Analysis” and “Generate Work Order.” in the second timestep.

In the second timestep, the computer system 202 further receives a user selection of a recommendation “Generate Work Order” as a third query of the set of queries. Upon receiving the user selection of the recommendation, the computer system 202 further executes the second AI agent 210-3 to generate a work order regarding a third task of the interconnected task sequence. As shown, for example, the second chat client displays a message as “Work Order #123 generated! . . . ”.

In the third timestep, the computer system 202 further executes the second AI agent 210-3 to analyze second data records associated with the work order, generate a review status based on this analysis, and share the review status with the conversational AI agent 210-1. The conversational AI agent 210-2 then renders the review status on the chat client 602. As shown, the chat client 602 displays a message as “Review Status: Work Order Completed at 16:30 3/22/2025. No Issues Detected . . . .”

Throughout these timesteps, the supervisor can view details and explainability provided by the agents, including feedback on root cause, confidence, and the data and models used in the analysis. The supervisor manually chooses the action recommended by the second AI agent 210-3 to create a work order to inspect the assets such as the transformer at risk, reviews, and approves the new work order. These steps ensure that the AI agents can effectively monitor assets conditions, detect potential issues, generate work orders, and provide detailed review statuses, thereby preventing disruptions and ensuring the safe operation of the assets.

It should be noted that the examples discussed in FIG. 6A and FIG. 6B are for exemplary purposes, and such examples should not be construed as limiting the present disclosure.

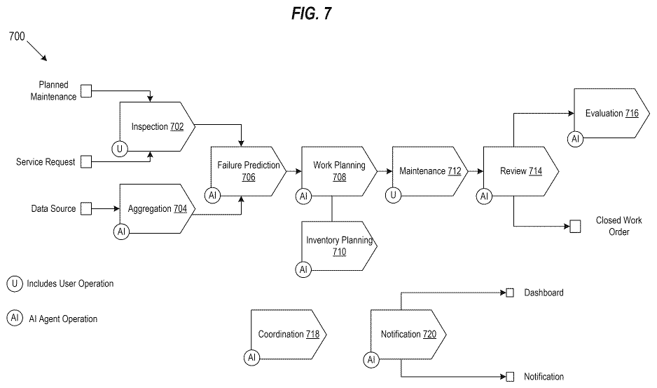

FIG. 7 is a block diagram that illustrates exemplary implementation of AI agents in a condition-based maintenance (CBM) process, in accordance with an embodiment of the disclosure. FIG. 7 is explained in conjunction with elements from FIG. 1, FIG. 2, FIG. 3, FIG. 4A, FIG. 4B, FIG. 5, FIG. 6A, and FIG. 6B. With reference to FIG. 7, there is shown a block diagram 700 of an exemplary CBM process. The CBM process is divided into a set of tasks which forms an interconnected task sequence. The set of tasks may include certain tasks for the users and certain tasks for the set of AI agents 210. As shown, the set of tasks include inspection 702, aggregation 704, failure prediction 706, work planning 708, inventory planning 710, maintenance 712, review 714, evaluation 716, coordination 718, and notification 720. For instance, except for inspection and maintenance, all tasks are managed by AI agents. These AI agents include either a single AI agent handling multiple tasks or different AI agents dedicated to specific tasks.

During the inspection 702, the input is a planned work order and service request. A user manually inspects the assets according to the inspection steps. The computer system 202 executes an AI agent to document the inspection progress and send the documented data to an AI agent responsible for the failure prediction task.

For the aggregation 704, the input is the data source (e.g., sensors and control systems). The computer system 202 executes an AI agent responsible for the ingestion and preprocessing of the ingested data. This data is accessible to both the AI agents for inspection and failure prediction.

For the failure prediction 706, the computer system 202 executes the AI agent to analyze the inputs (from inspection 702 and aggregation 704), predict anomalies with the asset, identify failure conditions (including failure class and mode), assess risk and priority, and determine actions. Based on these actions, the computer system 202 executes the AI agent generate a new work order.

For the work planning 708, the input is the new work order. The computer system 202 executes an AI agent to review the work order, which the user then approves. The AI agent schedules maintenance based on the approval and reserves resources and materials for the maintenance. The output is the planned work order.

The inventory planning 710 relies on the reservation process. The computer system 202 executes an AI agent to predict material use based on the new work order, create purchase orders, and initiate item transfers. This information is then updated to the AI agent responsible for work planning.

During the maintenance 712, the input is the planned work order. Users complete the maintenance actions, and the computer system 202 executes an AI agent to report the completed actions. The output is the completed work order status, which is sent to the AI agent responsible for the reviewing task.

For the review 714, the computer system 202 executes an AI agent to review the completed work order and close the completed work order. The closed work order is then sent to the evaluation agent for reporting KPIs, identifying process improvements, and evaluating failure conditions and actions.

The evaluation 716 involves the computer system 202 executing an AI agent to assess the overall performance and effectiveness of the maintenance actions. This includes evaluating the accuracy of the failure predictions and the efficiency of the work planning.

Coordination 718 includes an AI agent executed by the computer system 202 to enable communication and collaboration between different AI agents and users involved in the CBM process.

The notification 720 task is executed by an AI agent that sends alerts and updates to the relevant personnel. For example, the maintenance supervisor is notified of critical assets at risk through an operational dashboard configured with a card presenting the output of the agent network. The supervisor can view details and explainability provided by the agents, including feedback on root cause, confidence, and the data and models used in the analysis.

This foregoing description demonstrates how the computer system 202, through the execution of AI agents, effectively manages various tasks in the CBM process, ensuring timely and accurate maintenance actions, reducing downtime, and enhancing the overall reliability of the assets. It should be noted that the examples discussed in FIG. 7 are for exemplary purposes, and such examples should not be construed as limiting the present disclosure.

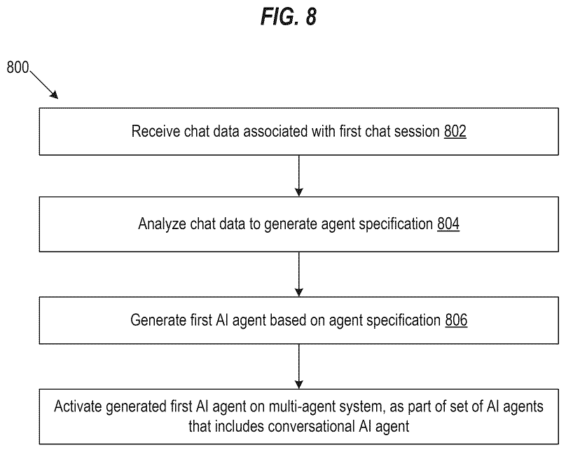

FIG. 8 is a diagram that illustrates a flowchart of an exemplary method for creating and managing AI agents based on chat conversations, in accordance with an embodiment of the disclosure. FIG. 8 is explained in conjunction with elements from FIG. 1, FIG. 2, FIG. 3, and FIG. 4A, FIG. 4B, FIG. 5, FIG. 6A, FIG. 6B, and FIG. 7. With reference to FIG. 8, there is shown a flowchart 800. The operations of the exemplary method may be executed by any computing system, for example, by the computer 102 of FIG. 1 or the computer system 202 of FIG. 2. The operations of the flowchart 800 may start at 802.

At 802, chat data associated with a first chat session is received. In an embodiment of the disclosure, the computer system 202 is configured to receive the chat data associated with the first chat session. The first chat session is between the chat client 214 and the conversational AI agent 210-1 for the neural language model 208 and the chat data is associated with a first task of an interconnected task sequence. Further details about the reception of the chat data are provided, for example, in FIG. 3.

At 804, the chat data is analyzed to generate an agent specification. In an embodiment of the disclosure, the computer system 202 is configured to analyze the chat data to generate an agent specification. Further details about the generation of the agent specification are provided, for example, in FIG. 3.

At 806, a first AI agent is generated based on the agent specification. In an embodiment of the disclosure, the computer system 202 is configured to generate the first AI agent 210-2 based on the agent specification. Further details about the generation of the first AI agent 210-2 are provided, for example, in FIG. 3.

At 808, the generated first AI agent 210-2 is activated on the multi-agent system 206, as part of the set of AI agents 210 that includes the conversational AI agent 210-1. In an embodiment of the disclosure, the computer system 202 is configured to activate the generated first AI agent 210-2 on the multi-agent system 206. The activation process ensures that the AI agent is operational and ready to interact with users and AI agents within the multi-agent system 206. The AI agent may now execute tasks, monitor conditions, and provide recommendations based on real-time data and user inputs. Further details about the activation are provided, for example, in FIG. 3.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable people of ordinary skill in the art to understand the embodiments disclosed herein.

What is claimed is:

1. A computer-implemented method, comprising:
receiving, by a computer, chat data associated with a first chat session,
the first chat session being between a first chat client and a conversational Artificial Intelligence (AI) agent for a neural language model, and
the chat data being associated with a first task of an interconnected task sequence;
analyzing, by the computer, the chat data to generate an agent specification;
generating, by the computer, a first AI agent based on the agent specification; and
activating, by the computer, the generated first AI agent on a multi-agent system, as part of a set of AI agents that includes the conversational AI agent.

2. The computer-implemented method of claim 1, further comprising:
receiving, by the computer, a first set of queries associated with the first task via the first chat client during the first chat session; and
executing, by the computer, the conversational AI agent, wherein the executing comprises:
extracting, by the computer, context information comprising first data records associated with the first task based on the first set of queries;
generating, by the computer, prompts for the neural language model based on the first set of queries and the context information; and
prompting, by the computer, the neural language model with the prompts to generate a first set of responses corresponding to the first set of queries,
wherein the chat data includes the first set of queries and the first set of responses, and the receiving of the chat data is performed based on the executing of the conversational AI agent.

3. The computer-implemented method of claim 2, wherein the conversational AI agent has access to a database storing the first data records or a sensor network generating the first data records.

4. The computer-implemented method of claim 1, further comprising:
generating, by the computer, a set of field values corresponding to a set of fields of a template agent specification based on the analysis of the chat data; and
populating, by the computer, the template agent specification with the set of field values to generate the agent specification.

5. The computer-implemented method of claim 4, wherein the analysis includes executing, by the computer, the conversational AI agent to prompt the neural language model with an instruction that includes the chat data, and
wherein the set of field values is generated as an output of the neural language model based on the instruction.

6. The computer-implemented method of claim 4, wherein the set of fields comprises one or more of:
a role of a user associated with the first chat client,
an access group that includes the user,
a name of the first AI agent,
a task scope,
an agent goal,
a state of the first AI agent,
a group of users different from the user with access to the first AI agent, or
a memory requirement for the first AI agent.

7. The computer-implemented method of claim 1, further comprising:
executing, by the computer, the first AI agent activated on the multi-agent system, wherein the executing comprises:
monitoring, by the computer, changes in first data records associated with the first task based on at least one of a task scope or an agent goal in the agent specification; and
generating, by the computer, alert information based on the changes satisfying a trigger condition; and
triggering, by the computer, the first chat client or a second chat client to display the alert information, the second chat client being different from the first chat client.

8. The computer-implemented method of claim 7, wherein the trigger condition is one of:
a user-defined rule for columns in the first data records,
an execution schedule specified in the agent specification, or
an anomaly in at least one record of the first data records.

9. The computer-implemented method of claim 7, wherein the executing further comprises:
searching, by the computer, for a plurality of Application Programming Interface (API) endpoints available to the multi-agent system;
determining, by the computer, at least one API endpoint from the plurality of API endpoints which serves the first data records associated with the first task; and
retrieving, by the computer, the first data records by calling the at least one API endpoint,
wherein the monitoring of the changes in the first data records is performed based on the retrieval.

10. The computer-implemented method of claim 9, wherein the executing further comprises:
training, by the computer, a machine learning model based on the first data records; and
deploying, by the computer, the machine learning model on a production server.

11. The computer-implemented method of claim 1, further comprising:
receiving, by the computer, a second set of queries via the first chat client or a second chat client during a second chat session for a second task of the interconnected task sequence;
executing, by the computer, a second AI agent of the set of AI agents to generate a set of recommendations, the generating of the set of recommendations being performed based on the second set of queries; and
triggering the first chat client or the second chat client to display the set of recommendations.

12. The computer-implemented method of claim 11, further comprising executing, by the computer, the conversational AI agent based on the second set of queries to trigger the execution of the second AI agent,
wherein the second AI agent is preconfigured for the second task on the multi-agent system and is different from the first AI agent.

13. The computer-implemented method of claim 11, further comprising:
receiving a user selection of a recommendation from the set of recommendations via the first chat client or the second chat client; and
executing, by the computer, the second AI agent to generate a work order regarding a third task of the interconnected task sequence.

14. The computer-implemented method of claim 13, further comprising:
executing, by the computer, the second AI agent of the set of AI agents to:
analyze second data records associated with the work order;
generate a review status of the work order based on the analysis of the second data records; and
sharing the review status with the conversational AI agent; and
executing the conversational AI agent to render the review status on the first chat client or the second chat client.

15. The computer-implemented method of claim 1, further comprising:
receiving, by the computer, a user input via the first chat client or a second chat client, the second chat client being different from the first chat client;
updating, by the computer, the agent specification based on the user input; and
activating, by the computer, the first AI agent on the multi-agent system further based on the updating.

16. The computer-implemented method of claim 1, further comprising forming, by the computer, a network of the set of AI agents with an interface for information exchange amongst at least two AI agents of the network.

17. The computer-implemented method of claim 1, wherein the interconnected task sequence is associated with a condition-based maintenance (CBM) process for assets, and
the interconnected task sequence includes one or more of a data aggregation task, an asset monitoring task, a data analysis task, a condition assessment task, a maintenance planning task, an inventory planning task, a maintenance scheduling task, a maintenance execution task, a work review task, or a feedback task.

18. The computer-implemented method of claim 1, further comprising:
receiving, by the computer, a user input based on the activation of the first AI agent; and
performing, by the computer, a pause operation, a cloning operation, or a delete operation on the first AI agent activated on the multi-agent system based on the user input.

19. A computer system, comprising:
a processor set;
one or more computer-readable storage media; and
program instructions stored on the one or more computer-readable storage media, the program instructions executable by the processor set to cause the processor set to:
receive chat data associated with a first chat session,
the first chat session being between a first chat client and a conversational Artificial Intelligence (AI) agent for a neural language model, and
the chat data being associated with a first task of an interconnected task sequence;
analyze the chat data to generate an agent specification;
generate a first AI agent based on the agent specification; and
activate the generated first AI agent on a multi-agent system, as part of a set of AI agents that includes the conversational AI agent.

20. A computer-program product for a multi-agent system, the computer-program product comprising:
one or more computer-readable storage media; and
program instructions stored on the one or more computer-readable storage media to perform operations comprising:
receiving chat data associated with a first chat session,
the first chat session being between a first chat client and a conversational Artificial Intelligence (AI) agent for a neural language model, and
the chat data being associated with a first task of an interconnected task sequence;
analyzing the chat data to generate an agent specification;
generating a first AI agent based on the agent specification; and
activating the generated first AI agent on the multi-agent system, as part of a set of AI agents that includes the conversational AI agent.
